(19) United States
(12) Patent Application Publication
(10) Pub. No.: US 2013/0321267 A1
(43) Pub. Date: Dec. 5, 2013

(54) DYNAMICALLY CHANGING A CHARACTER ASSOCIATED WITH A KEY OF A KEYBOARD

(71) Applicants: Omar Ahmad Bhatti, Gouvieux (FR); Marc Verstaen, Redwood City, CA (US); Christopher P. Willmore, Santa Clara, CA (US); Morgan H. Winer, Sunnyvale, CA (US); Julien J. Jalon, San Francisco, CA (US)

(72) Inventors: Omar Ahmad Bhatti, Gouvieux (FR); Marc Verstaen, Redwood City, CA (US); Christopher P. Willmore, Santa Clara, CA (US); Morgan H. Winer, Sunnyvale, CA (US); Julien J. Jalon, San Francisco, CA (US)

(73) Assignee: Apple Inc., Cupertino, CA (US)

(21) Appl. No.: 13/488,027

(22) Filed: Jun. 4, 2012

(51) Int. Cl. G06F 3/02; G06F 3/033

(52) U.S. Cl. 345/157; 345/169

(57) ABSTRACT

A software keyboard is provided with a dedicated key (dynamic character key) for inputting a character, where the character associated with the key is determined based upon a context and may dynamically change according to the context. For example, a first character may be dynamically determined and associated with the dedicated key for a first context and a second character, possibly different from the first character, may be selected and associated with the dedicated key for a different context. The character that is associated with the dynamic character key may also be displayed on the dynamic character key. In some embodiments, the character associated with the dynamic character key may be a non-alphanumeric character such as a diacritical mark, a punctuation mark, and the like.

### BACKGROUND

The disclosed embodiments relate generally to keyboards and more particularly to improved techniques for inputting characters using a software keyboard.

With the advent and popularity of mobile computing devices such as the iPhone®, iPod Touch®, and iPad® devices from Apple Inc. of Cupertino, Calif., the conventional physical or hardware keyboard has in many instances given way to a software keyboard (also sometimes referred to as a soft keyboard or virtual keyboard). A software keyboard is generally displayed by the computing device, typically on a touch screen. The software keyboard can comprise a number of soft keys for inputting information. A user of the computing device can use the software keyboard to provide inputs (e.g., characters) to the computing device.

Due to the size of mobile devices, the display area available for displaying a software keyboard is generally limited. This leads to several limitations. For example, due to the reduced area, the number of soft keys that can be displayed by a software keyboard at any one time, while still ensuring that the user can type easily, is limited. A majority of these keys are dedicated to displaying alphanumeric characters (i.e., letters and numbers) with a very limited number available for non-alphanumeric characters (e.g., punctuations, diacritical marks, etc.). For example, on several software keyboards, in order to access a full range of non-alphanumerical characters, the user has to shift from a normal mode to a different mode that displays a different software keyboard layout comprising a set of non-alphanumeric keys. This however is not very convenient and significantly slows down the typing speed.

Several computing devices nowadays provide multiple software keyboards, each customized for a particular language. A user of the computing device can typically select a particular software keyboard to be displayed per the user's preferences or needs. Customizing a software keyboard for a particular language enables the keyboard to display characters and other characteristics (e.g., diacritical marks) that are particular to that language. For example, French provides for multiple different diacritical marks including an acute accent (´), a grave accent (`), a circumflex (̂), an umlaut (\ddot{}), and a cedilla ( [symbol] ), that are used to modify various characters. Accordingly, a French software keyboard needs to provide the ability to enter the diacritical marks or alternatively to enter characters that are modified by the diacritical marks (sometimes referred to as diacritical characters).

This need for providing the ability to input diacritical marks via a software keyboard provides a whole new set of challenges for keyboard designers. Some conventional approaches attempt to solve the problem by providing multiple keyboard keys, each key dedicated to a particular diacritical mark or diacritical character provided by a language. This approach however significantly increases the number of keys on the keyboard and is not a practical solution where the on-screen area for displaying a software keyboard is limited, which is usually the case. Other solutions require key combinations to input a diacritical mark or diacritical character. Such combinations are however non-intuitive and thus very difficult to remember thereby distracting from the user's typing experience.

### BRIEF SUMMARY

Certain embodiments are described that provide improved techniques for inputting characters using a software keyboard.

In some embodiments, a software keyboard is provided comprising a dedicated key for inputting a character, where the character associated with the key is determined based upon a context and may change according to the context. For example, a first character may be dynamically determined and associated with the dedicated key for a first context such that selecting the dedicated key results in the associated first character being input. A change in the context may cause a different character to be selected and associated with the dedicated key, thereby changing the character that is input when the dedicated key is selected. In this manner, the character that is associated with the dedicated key is dynamically determined and changed based upon the context. The dedicated key may thus be referred to as the “dynamic character key”. The dynamic character key is thus repurposed based upon the context.

In some embodiments, the character that is associated with the dynamic character key may also be displayed on the dynamic character key. This enables a user of the software keyboard to easily determine the character that is currently associated with the dynamic character key. When there is a change in the character associated with the dynamic character key, the character displayed on the dynamic character key is also dynamically changed to reflect the newly associated character. In this manner, the character displayed on a dynamic character key is automatically and dynamically updated as a new character is associated with the dynamic character key.

in some embodiments, the character that is dynamically associated with the dynamic character key is a non-alphanumeric character. Examples of a non-alphanumeric character include but are not limited to a diacritical mark (e.g., acute accent (´), grave accent (`), circumflex (̂), umlaut (\ddot{}), cedilla, etc), a punctuation mark (e.g., an apostrophe ('), a hyphen, a dash, a comma, a period), a synibol, and the like. When the dynamic character key is selected, for example, by the user hitting the key while typing, the non-alphanumeric character that is currently associated with the dynamic character key is input.

For example, for a first context, a first non-alphanumeric character may be selected from among multiple non-alphanumeric characters and be associated with the dynamic character key. When the first non-alphanumeric character is associated with the dynamic character key, selection of the dynamic character key, for example, during typing, results in the first non-alphanumeric character being input. Upon detecting a change in context from a first context to a second context, a second non-alphanumeric character different from the first non-alphanumeric character and that is a better fit for that context may be selected from the multiple non-alphanumeric characters and be associated with the dynamic character key instead of the first non-alphanumeric character. When the second non-alphanumeric character is associated with the dynamic character key, selection of the same dynamic character key results in the second non-alphanumeric character being input.

In some embodiments, the non-alphanumeric character that is associated with the dynamic character key may be a diacritical mark. For a language such as French that provides multiple diacritical marks, a particular diacritical mark to be associated with the dynamic character key may be determined dynamically based upon the context. A change in the context may cause a different diacritical mark to be selected and associated with the dynamic character key, thereby changing the diacritical mark that is input when the dynamic character key is selected. In this manner, the diacritical mark that is associated with the dynamic character key is dynamically determined and changed based upon the context. The dynamic character key is thus repurposed based upon the context.

In some embodiments, input of a diacritical mark upon selecting the dynamic character key causes a character immediately preceding the current cursor position to be modified using the input diacritical mark to create a diacritical character. For example, if the input diacritical mark is a circumflex (̂) and the character immediately preceding the cursor position is an ‘a’, then it result in the ‘a’ being converted to ‘â’.

In some embodiments, the non-alphanumeric character that is associated with the dynamic character key may be a punctuation. For example, for a particular context, a particular punctuation may be selected and associated with the dynamic character key. When the particular punctuation is associated with the dynamic character key, selection of the dynamic character key results in the punctuation character being input.

In some embodiments, various techniques such as a method, system, or a computer-readable memory storing a plurality of instructions for controlling one or more processors, may be provided for enabling a software keyboard with enhanced capabilities for inputting characters. In one embodiment, a software keyboard may be displayed comprising a set of keys including a dynamic character key, where the character associated with the dynamic character key is dynamically determined. A text portion to be used for selecting a character, from among multiple characters, to be associated with the dynamic character key may be determined. Based upon the text portion and reference information for a language, a first character that is to be associated with the dynamic character key is determined. The first character is then associated with the dynamic character key such that selection of the dynamic character key causes the first character to be input. The first character is also displayed on the dynamic character key of the software keyboard.

In some embodiments, a change in context may trigger processing for selecting a character to be associated with the dynamic character key. For example, a second character may be determined, from the multiple characters, to be associated with the dynamic character key instead of the first character, where the second character is different from the first character. The character associated with the dynamic character key is then changed from the first character to the second character such that selection of the dynamic character key causes the second character to be input. The second character is also displayed on the dynamic character key instead of the first character.

The reference information that is used for determining a character to be associated with a dynamic character key may come in different forms. In some embodiments, the reference information may be a set of rules for a language. A text portion to be used for determining a character to be associated with the dynamic character key may be determined based upon a cursor position. For example, the text portion may correspond to a text preceding the cursor position and ending at the character immediately preceding the cursor position. The character to be associated with the dynamic character key may then be determined by applying one or more rules from the set of rules to the text portion.

In some other embodiments, the reference information may be a list of words, such as a dictionary. A set of one or more words may be determined from the list of words based upon the text portion. For example, all words in the list that start with the text portion may be identified. The character to be associated with the dynamic character key is then determined based upon the set of one or more words.

some embodiments, the reference information may be a lookup table. Given a text portion, the lookup table may be used to determine a character mark to be associated with the dynamic character key.

In some embodiments, a long-press of the dynamic character key may display a popup menu displaying the character associated with the dynamic character key. This provides an alternative way for a user to select the character associated with the dynamic character key.

In some embodiments, the character that is associated with the dynamic character key may be selected from a set of non-alphanumeric characters. Examples of non-alphanumeric characters include but are not limited to a diacritical mark, a punctuation, etc. For example, there are several languages that provide multiple diacritical marks. One such language is the French language, which provides multiple diacritical marks including an acute accent (´), a grave accent (`) a circumflex (̂), an umlaut (\ddot{}), and a cedilla ( [symbol] ). A software keyboard with a dynamic character key may be provided such that a selected one of these diacritical marks is dynamically associated with the dynamic character key based upon the context.

For a dynamic character key associated with a diacritical mark, selection of the dynamic character key causes the associated diacritical mark to be input. The diacritical mark that is input is used to modify the character immediately preceding a cursor to generate a diacritical character.

In some embodiments, a software keyboard comprising a set of keys may be displayed by a computing device. The set of keys may include a dynamic character key that is associated with a first character from multiple characters. The computing device may determine that a second character from the multiple characters is to be associated with the dynamic character key instead of the first character, where the second character is different from the first character. The character associated with the dynamic character key is then changed from the first character to the second character such that selection of the dynamic character key causes the second character to be input to the computing device. The second character may also be displayed on the dynamic character key. This enables a user of the software keyboard to easily determine the character that is currently associated with the dynamic character key.

### BRIEF DESCRIPTION OF THE DRAWINGS

FIGS. 1-9 depict examples of software keyboards that enable improved techniques for inputting character according to some embodiments;

FIG. 10 depicts a simplified diagram of a system that may incorporate an embodiment;

FIG. 11 depicts a simplified flowchart depicting a method for dynamically selecting a character and associating the character with a dynamic character key according to some embodiments;

FIG. 12 depicts a simplified flowchart depicting a method for dynamically selecting a character to be associated with a dynamic character key using dictionary (or any list of words) reference information according to some embodiments;

FIG. 13 depicts an example of a software keyboard displayed by an iPhone® device from Apple Inc. of Cupertino, Calif., that enables improved techniques for inputting characters using a dynamic character key according to some embodiments;

FIG. 14 is a simplified block diagram of a computer system that may incorporate components of a system for providing a software keyboard with a dynamic character key according to some embodiments; and

FIG. 15 depicts a simplified diagram of a distributed system for providing a software keyboard with a dynamic character key according to some embodiments.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

For purposes of this disclosure, the term “character” can refer to a printable or a non-printable character.

For purposes of this disclosure, the term “alphanumeric character” refers to a character that is either a letter (lower case or upper case) or a number.

For purposes of this disclosure, the term “non-alphanumeric character” refers to any character that is not an alphanumeric character. Examples of a non-alphanumeric character include but are not limited to a diacritical mark (e.g., acute accent (´), grave accent (`), circumflex (̂), umlaut (\ddot{}), cedilla, etc.), a punctuation mark (e.g., an apostrophe ('), a hyphen, a dash, a comma, a period), a symbol, and the like.

Certain embodiments are described that provide improved techniques for inputting characters using a software keyboard. In some embodiments, a software keyboard is provided comprising a dedicated key for inputting a character, where the character associated with the key is determined based upon a context and may change according to the context. For example, a first character may be dynamically determined and associated with the dedicated key for a first context such that selecting the dedicated key results in the associated first character being input. A change in the context may cause a different character to be selected and associated with the dedicated key, thereby changing the character that is input when the dedicated key is selected. In this manner, the character that is associated with the dedicated key is dynamically determined and changed based upon the context. The dedicated key may thus be referred to as the “dynamic character key”. The dynamic character key is thus repurposed based upon the context.

In some embodiments, the character that is associated with the dynamic character key may also be displayed on the dynamic character key. This enables a user of the software keyboard to easily determine the character that is currently associated with the dynamic character key. When there is a change in the character associated with the dynamic character key, the character displayed on the dynamic character key is also dynamically changed to reflect the newly associated character. In this manner, the character displayed on a dynamic character key is automatically and dynamically updated as a new character is associated with the dynamic character key.

In some embodiments, the character that is dynamically associated with the dynamic character key is a non-alphanumeric character. Examples of a non-alphanumeric character include but are not limited to a diacritical mark (e.g., acute accent (´), grave accent (`), circumflex (̂), umlaut (\ddot{}), cedilla, etc.), a punctuation mark (e.g., an apostrophe ('), a hyphen, a dash, a comma, a period), a symbol, and the like. When the dynamic character key is selected, for example, by the user hitting the key while typing, the non-alphanumeric character that is currently associated with the dynamic character key is input.

For example, for a first context, a first non-alphanumeric character may be selected from among multiple non-alphanumeric characters and be associated with the dynamic character key. When the first non-alphanumeric character is associated with the dynamic character key, selection of the dynamic character key, for example, during typing, results in the first non-alphanumeric character being input. Upon detecting a change in context from a first context to a second context, a second non-alphanumeric character different from the first non-alphanumeric character and that is a better fit for that context may be selected from the multiple non-alphanumeric characters and be associated with the dynamic character key instead of the first non-alphanumeric character. When the second non-alphanumeric character is associated with the dynamic character key, selection of the same dynamic character key results in the second non-alphanumeric character being input. In this manner, the diacritical mark that is associated with the dynamic character key is dynamically and intelligently determined and changed based upon the context. The dynamic character key is thus repurposed based upon the context.

In some embodiments, the non-alphanumeric character that is dynamically determined and associated with the dynamic character key may be a diacritical mark. A “diacritical mark” is a type of non-alphanumeric character and refers to a mark or glyph that is associated with or attached to a letter or character thereby modifying the letter or character to form a modified letter or character. The modified letter or character is referred to as a “diacritical character” or a “diacritical letter”. In some languages, a diacritical letter or character is treated as a new, distinct letter. In some languages, some diacritical marks are sometimes referred to as accents (e.g., the acute accent (´) and the grave accent (`).

Diacritical marks are provided in several languages and are used to modify one or more letters or characters of a language. For example, a diacritical mark may be associated with or attached to a letter or character to change the phonetic value of the letter or character, to indicate stress, and the like. The set of diacritical marks provided or used in one language may differ from another language. Further, the manner in which diacritical marks are used may differ from one language to another. The position of a diacritical mark with respect to the letter that is modified may also vary from one language to another and from one mark to another. For example, a diacritical mark modifying a letter may be placed before, after, above, below, or around the letter being modified.

For a language such as French that provides multiple diacritical marks, a particular diacritical mark to be associated with the dynamic character key may be determined dynamically based upon the context. For example, french provides for multiple different diacritical marks including an acute accent (´), a grave accent (`), a circumflex (̂), an umlaut (\ddot{}), and a cedilla ( [symbol] ) that are used to modify various characters. For example, in French:
the acute accent (´) may modify a letter ‘e’ (and its capitalized version) to form diacritical letter “é”;
the grave accent (`) can modify letters ‘a’, ‘e’, or ‘iu’ (and their versions) to form diacritical letters ‘à’, ‘`’, and ‘ù’;
a circumflex (̂) can modify letters ‘a’, ‘e’, ‘i’, ‘o’, or ‘u’ (and their capitalized versions) to form diacritical letters ‘â’, ‘ê’, ‘î’, ‘ô’, and ‘û’;
an umlaut (\ddot{}) can modify letters ‘e’, ‘i’, or ‘u’ (and their capitalized versions) to form diacritical characters ‘ë’, ‘ï’, and ‘ü’; and a cedilla ( [symbol] ) can modify letter ‘c’ (and its capitalized version) to form diacritical character ‘ç’.

In some embodiments, a first diacritical mark may be determined and associated with the dynamic character key. The first diacritical mark may also be displayed on the dynamic character key. A change in the context may cause a different diacritical mark to be selected and associated with the dynamic character key, thereby changing the diacritical mark that is input when the dynamic character key is selected. In this manner, the diacritical mark that is associated with the dynamic character key is dynamically determined and changed based upon the context. The dynamic character key is thus repurposed based upon the context.

Embodiments of the present invention may be used for various languages that provide diacritical marks. While several examples are provided below based upon the French language, this is not intended to be limiting. Various embodiments may also be used with other languages that provide diacritical marks. Examples of such languages include but are not restricted to Arabic, Catalan, Czech, Danish, Greek (ancient and modern), Spanish, Estonian, Farsi, Finnish, French, Hawaiian (it could offer okina and macron), Hindi, Croatian, Hungarian, Icelandic, Lithuanian, Latvian, Norwegian, Polish, Portuguese, Romanian, Slovak, Serbian (in Latin script), Swedish, Thai, Turkish, Vietnamese, and the like. In general, embodiments based upon the teachings in the present disclosure can be used for entering diacritical marks for any language that uses multiple diacritical marks.

In some embodiments, input of a diacritical mark upon selecting the dynamic character key causes a character immediately preceding the current cursor position to be modified using the input diacritical mark to create a diacritical character. For example, if the input diacritical mark is a circumflex (̂) and the character immediately preceding the cursor position is an ‘a’, then it result in the ‘a’ being converted to ‘â’.

In some embodiments, the non-alphanumeric character that is associated with the dynamic character key may be a punctuation. For example, for a particular context, a particular punctuation may be selected and associated with the dynamic character key. When the particular punctuation is associated with the dynamic character key, selection of the dynamic character key results in the punctuation character being input.

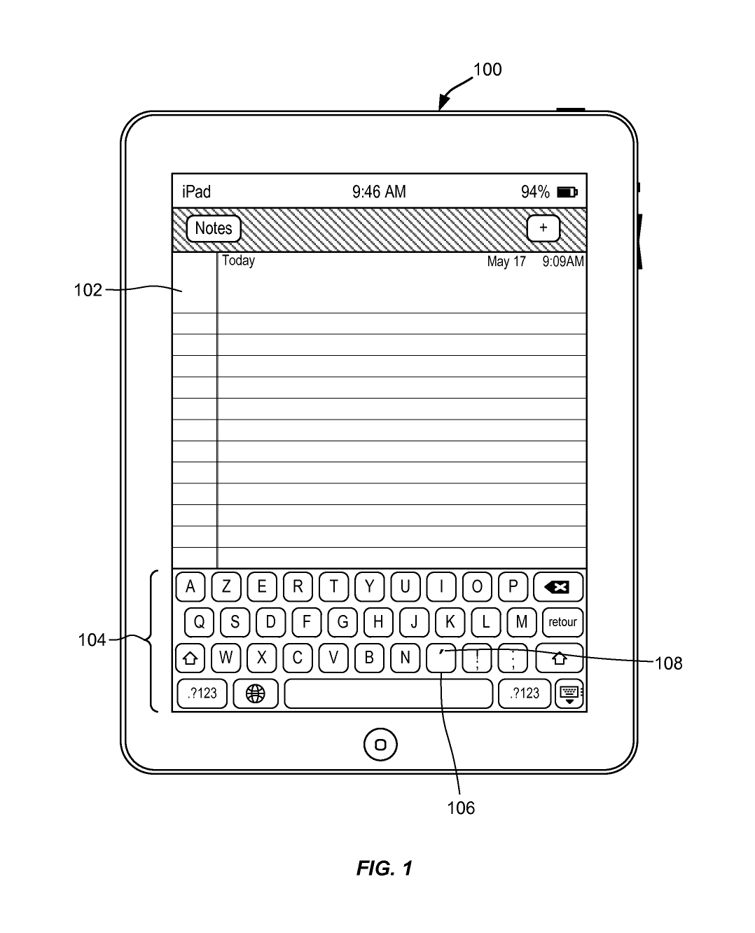

FIGS. 1-9 depict examples of software keyboards that enable improved techniques for inputting characters according to some embodiments. The examples depicted in FIGS. 1-9 are not intended to be limiting.

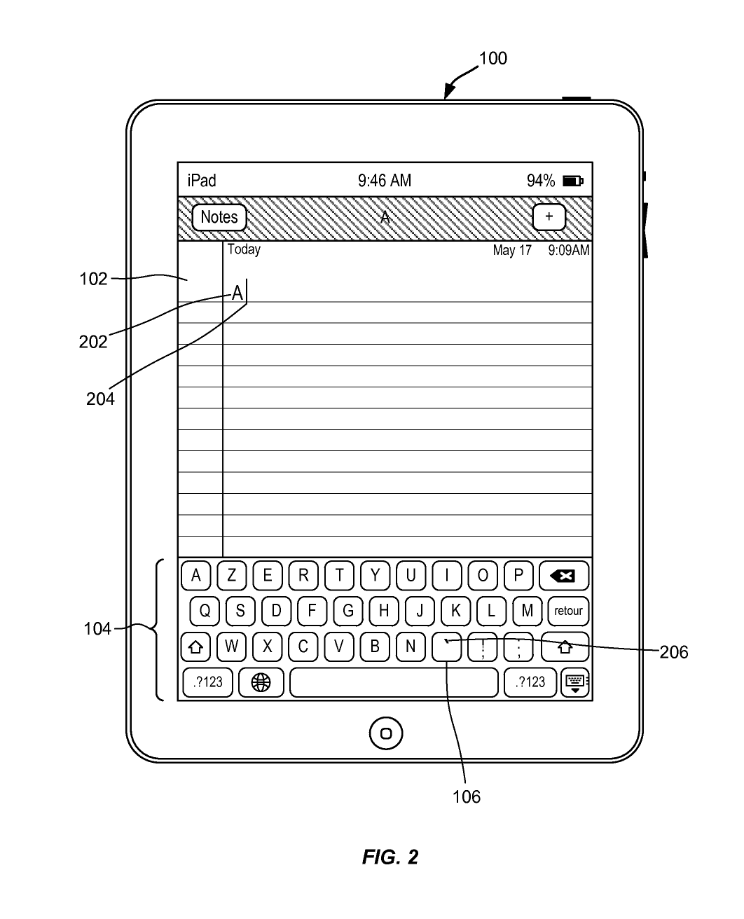

In FIG. 1, a computing device 100 is shown displaying a software keyboard 104 overlaid on a user interface 102 corresponding to an application being executed by computing device 100. In the example shown in FIG. 1 (and in FIGS. 2-9), the computing device is an iPad® device from Apple Inc. of Cupertino, Calif. In some alternative embodiments, computing device 100 can be any other computing device including a portable or non-portable device. Exemplary embodiments of computing devices include, without limitation, the iPhone® and iPod Touch® devices from Apple Inc. of Cupertino, Calif., other mobile devices, desktop computers, kiosks, and the like.

In FIGS. 1-9, the user interface 102 depicted by computing device 100 is for the “Notes” application. This however is not intended to be limiting. Software keyboard embodiments based upon the teaching of the present disclosure may be used with any application in which a user can input text using a software keyboard.

Software keyboard 104 depicted in FIG. 1 (and in FIGS. 2-9) is a keyboard customized for the French language. This again is not intended to be limiting. Software keyboard 104 comprises multiple keys including a dynamic character key 106 dedicated for inputting a character, which can be a non-alphanumeric character. In the embodiment depicted in FIG. 1, the character associated with dynamic character key 106 is a diacritical mark 108 (acute accent (´)), which is also displayed on dynamic character key 106. As a result of this association, if the user were to select dynamic character key 108, for example, by hitting dynamic character key 106, the acute accent ‘´’ would be input.

In FIG. 1, the user has not yet entered any text in the Notes application. In this case, when software keyboard 104 is displayed, a default or preconfigured character may be associated with and displayed on dynamic character key 106. In the example depicted in FIG. 1, this default character is the acute accent ‘´’. However, it is not necessary that a default character be associated with dynamic character key 106. In some alternative embodiments, no specific character may be associated with dynamic character key 106 when software keyboard 104 is first displayed.

In FIG. 2, a user has entered text “A” 202 in the Notes application. Position 204 denotes the position of the cursor, which marks the spot for entry of the next character. As can be seen in FIG. 2, in response to entry of text “A” 202, the character mark associated with dynamic character key 106 has been dynamically changed from acute accent (´) (shown in FIG. 1) to another diacritical mark, namely, the grave accent (`), and the character displayed on dynamic character key 106 is changed to accent (´) 206 to reflect the change in association. Now, if the user were to select dynamic character key 106, the grave accent (´) would be input.

The input of text “A” represents a change in context from the context state in FIG. 1, and this triggers processing to determine a character that is best suited given the changed context. In one embodiment, the grave accent (´) is selected because it is determined to be the diacritical mark that is statistically most likely to be input by a user after “A”. In some embodiments, the processing to select a character to be associated with the dynamic character key involves determining a text portion based upon the current cursor position and using the text portion for selecting a character to be associated with the dynamic character key. In one embodiment, the text portion is a portion of text immediately preceding cursor position 204. In the example depicted in FIG. 2, this text portion is “A”. The character to be associated with dynamic character key 106 is determined using this text portion along with reference information fir the French language. In one embodiment, the character to be associated with dynamic character key 106 is selected from a set of non-alphanumeric characters including diacritical marks and punctuations. Further details related to processing performed to select a character to be associated with dynamic character key 106 are described below.

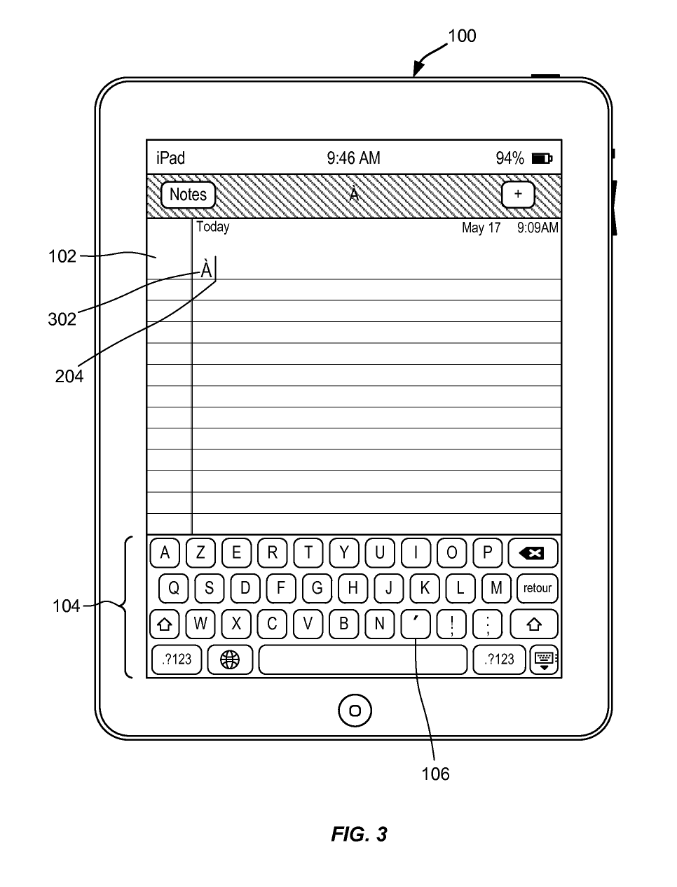

When the grave accent (´) is associated with dynamic character key 106, selection of dynamic character key 106 causes the grave accent (`) to be input. FIG. 3 depicts the effect of selecting dynamic character key 106 and inputting the grave accent (´). As shown in FIG. 3, inputting the grave accent (`) has caused the letter “A” 202 (in FIG. 2) to be modified to generate diacritical letter “À” 302. As can be seen from this example, inputting a diacritical mark by selecting dynamic character key 106 causes the character or letter immediately preceding the cursor position 204 to be modified by the input diacritical mark to generate a diacritical character. FIG. 3 also shows that input of the diacritical mark has caused a reprocessing of the character associated with dynamic character key 106, which has reverted back to the default character, which is the acute accent (´).

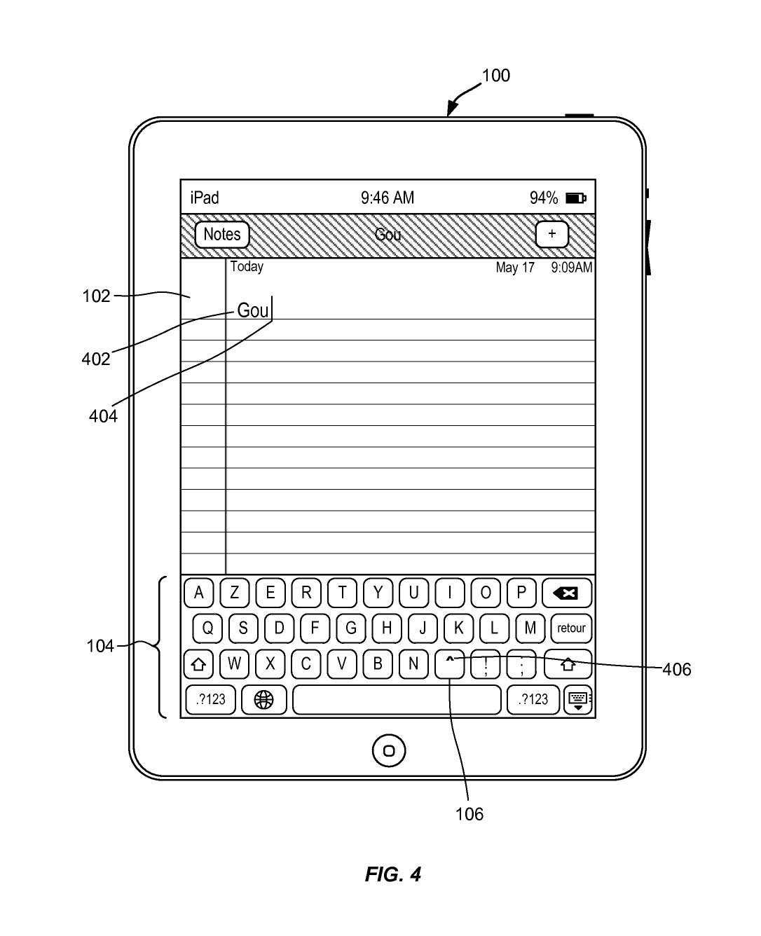

FIGS. 4-9 show additional examples of how the character associated with dynamic character key 106 can be dynamically changed based upon the context. In the example depicted in FIG. 4, text “Gou” 402 has been entered into the Notes application with position 404 representing the cursor position. As a result of this input, circumflex (̂) has been selected and associated with dynamic character key 106. Circumflex (̂) 406 is also displayed on dynamic character key 106 to reflect the association. In one embodiment, for cursor position 404, the text portion “Gou” 402 may be used as the text portion for determining which character to associate with dynamic character key 106.

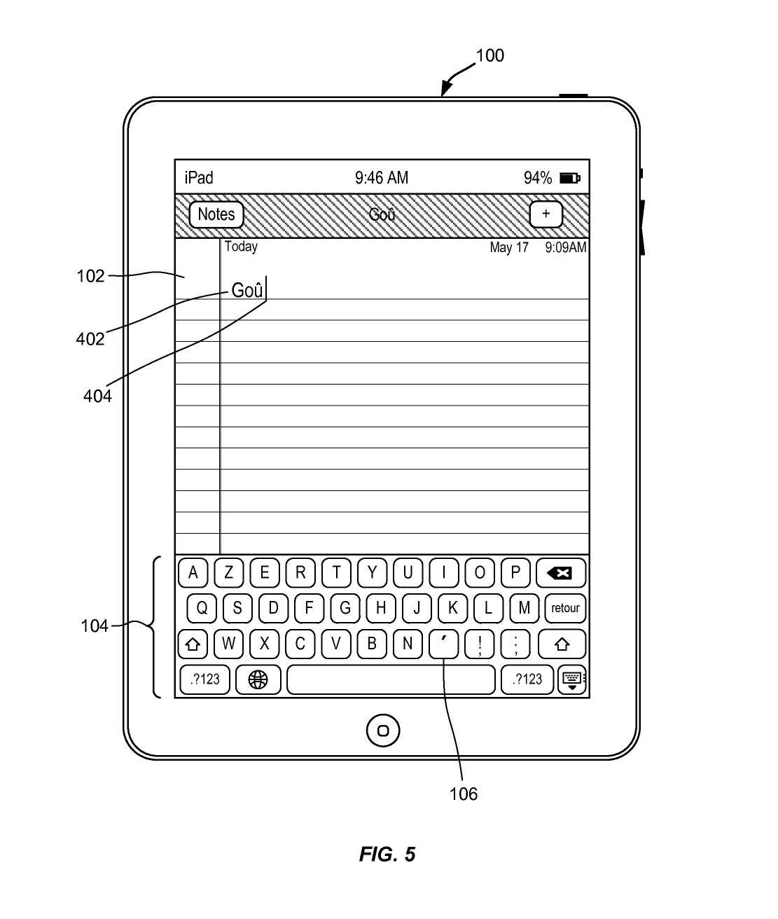

FIG. 5 depicts the effect of selecting dynamic character key 106 when the circumflex (̂) diacritical mark is associated with it. As shown in FIG. 5, inputting the circumflex (̂) has caused the letter ‘u’ of text portion “Gou” 402 (in FIG. 4) to be modified to generate diacritical letter ‘û’. FIG. 5 also shows that the character associated with dynamic character key 106 has reverted back to the default character, which is the acute accent (´).

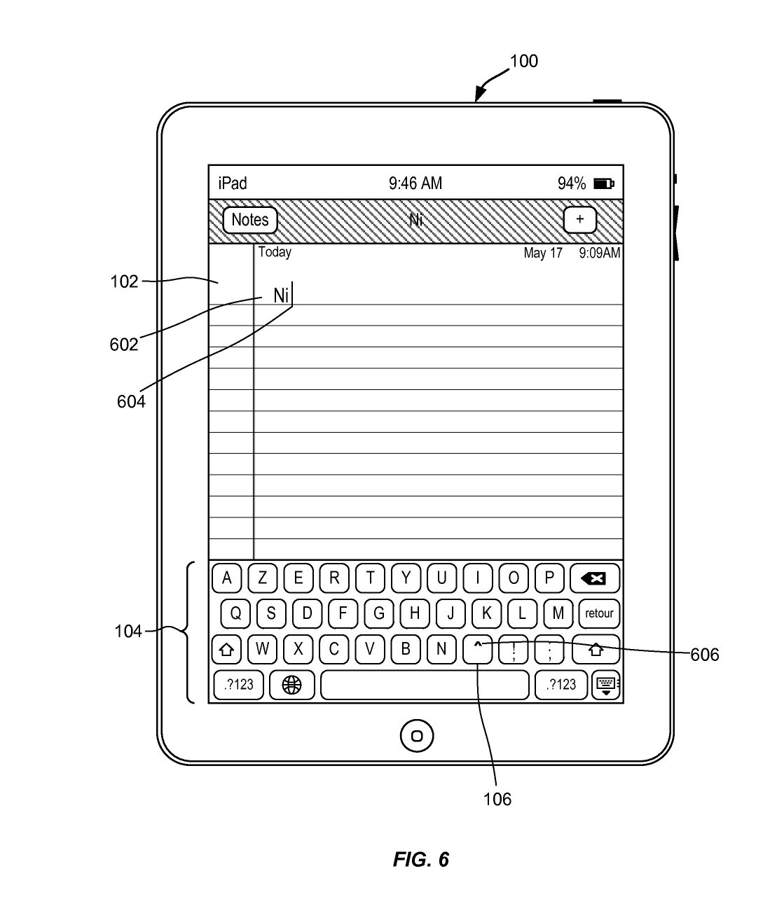

In the example depicted in FIG. 6, text “Ni” 602 has been entered into the Notes application with position 604 representing the cursor position. As a result of this input, circumflex (̂) has again been selected and associated with dynamic character key 106. Circumflex (̂) 606 is also displayed on dynamic character key 106 to reflect the association. In this example, “Ni” 602 may be used as the text portion for determining which character to select and associate with dynamic character key 106. If the user wishes to modify letter ‘i’ in “Ni” with the circumflex (̂), the user can select dynamic character key 106 by hitting it and this will cause “Ni” to become “Nî”.

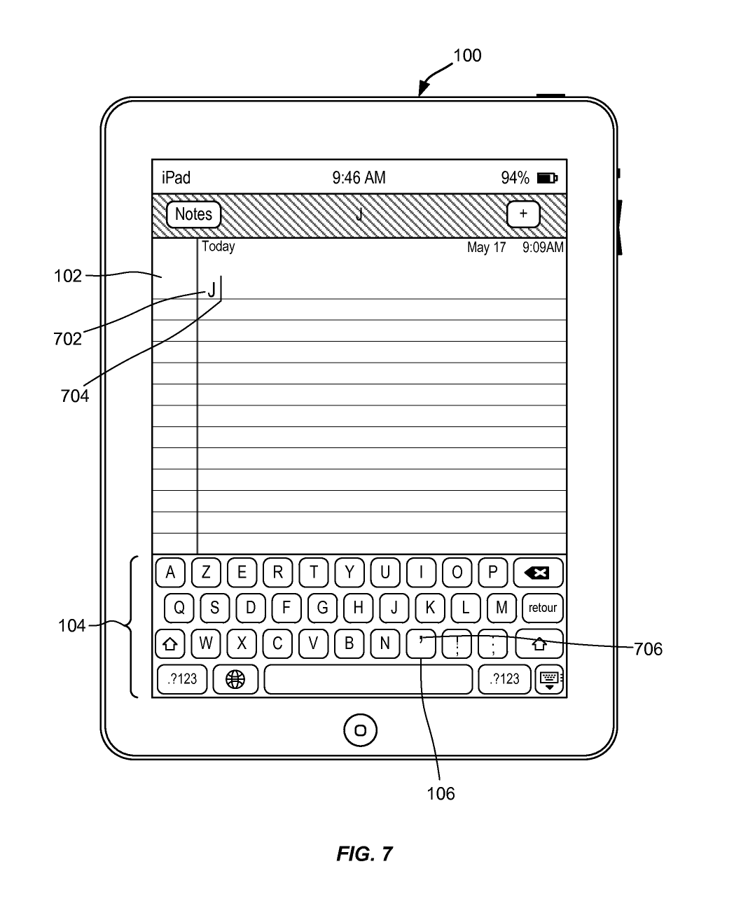

In the example depicted in FIG. 7, character “J” 702 has been entered into the Notes application with position 704 representing the cursor position. As a result of this input, a punctuation mark, namely, an apostrophe ('), has been selected and associated with dynamic character key 106. Apostrophe (') 706 is also displayed on dynamic character key 106 to reflect the association. In this example, “J” 702 may be used as the text portion for determining which character to select and associate with dynamic character key 106. Selection of dynamic character key 106 with the cursor in position 702 would cause the apostrophe to be input resulting in text “J'”.

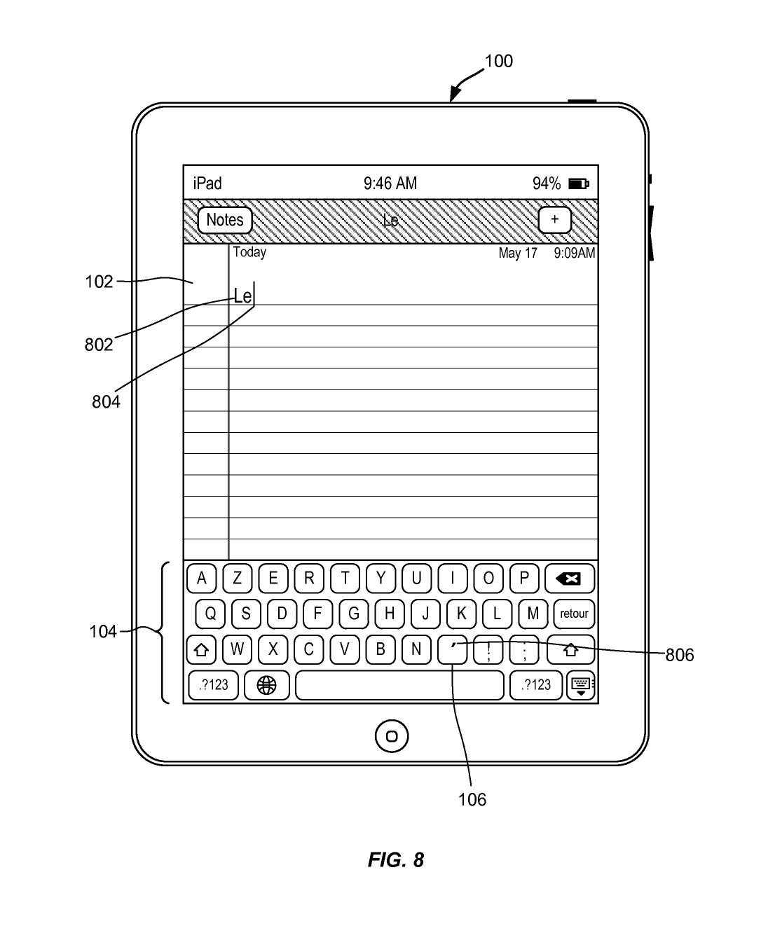

In the example depicted in FIG. 8, a text portion “Le” 802 has been entered into the Notes application with position 804 representing the cursor position. As a result of this input, a diacritical mark, namely, the acute accent (´), has been selected and associated with dynamic character key 106. Acute accent (´) 806 is also displayed on dynamic character key 106 to reflect the association. In this example, text portion “Le” 802 may be used as the text portion for determining which character to select and associate with dynamic character key 106. Selection of dynamic character key 106 with the cursor in position 802 would cause “Le” to change to “Lé”.

As described above, a user while typing can select the dynamic character key and the character associated with the dynamic character key at that time is input. If the associated character is a diacritical mark, then input of the diacritical mark causes the character immediately preceding the cursor to be modified to generate a diacritical character. If the associated character is a punctuation, then input of the punctuation causes the punctuation to be inserted in the position marked by the cursor.

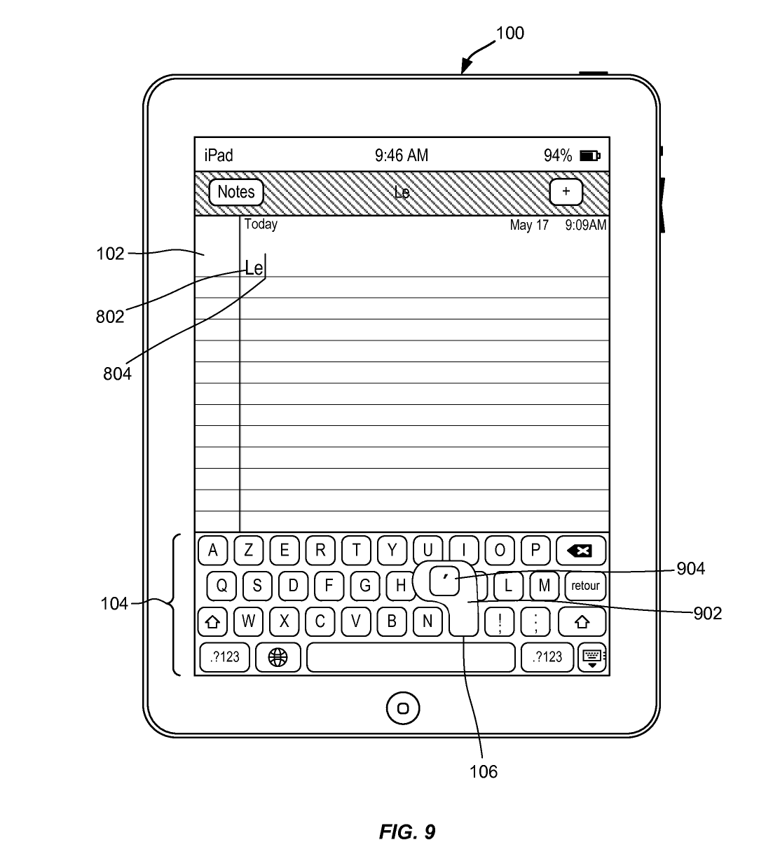

FIG. 9 depicts an example showing an alternative user interface for inputting a character associated with a dynamic character key. In FIG. 9, a long-press on dynamic character key 106 causes a popup menu 902 to be displayed. Popup menu 902 displays the character 904 (in this example, acute accent (´)) currently associated with dynamic character key 106. The user can input the character by selecting character 904 from popup menu 902. In the example depicted in FIG. 9, selection of mark 904 would cause “Le” to change to “Lé”.

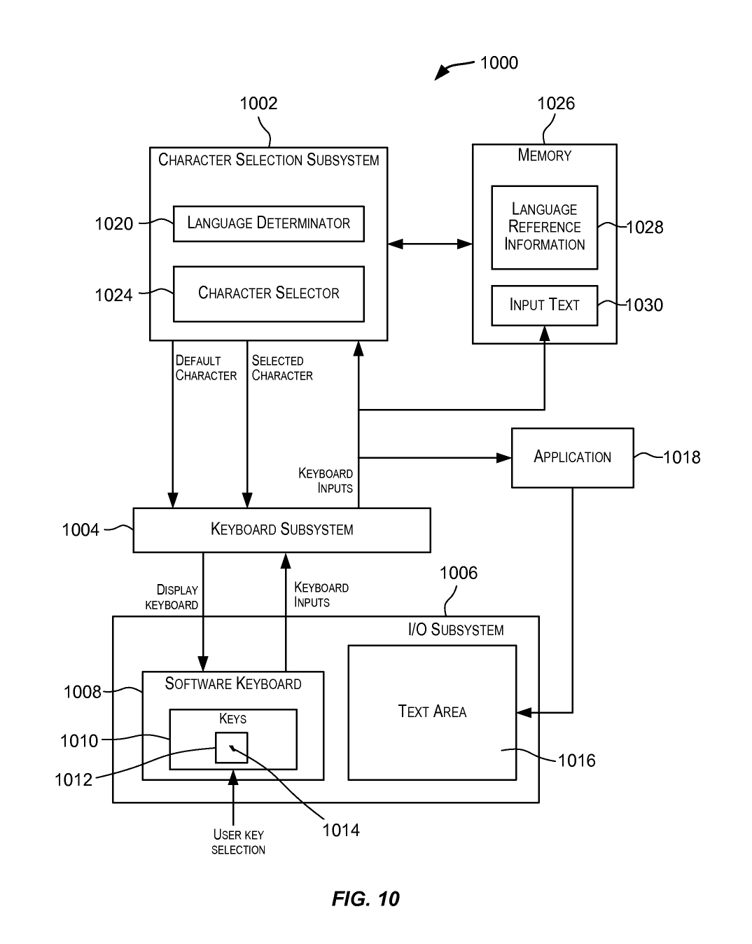

FIG. 10 depicts a simplified diagram of a system 1000 that may incorporate an embodiment of the present invention. In the embodiment depicted in FIG. 10, system 1000 includes multiple subsystems including a character selection subsystem 1002, a keyboard subsystem 1004, an input/output (I/O) subsystem 1006, and a memory 1026. One or more communication paths may be provided enabling one or more of the subsystems to communicate with and exchange data with one another. One or more of the subsystems depicted in FIG. 10 may be implemented in software, in hardware, or combinations thereof. In some embodiments, the software may be stored on a transitory or non-transitory computer readable medium and executed by one or more processors of system 1000.

It should be appreciated that system 1000 depicted in 10 may have other components than those depicted in FIG. 10. Further, the embodiment shown in FIG. 10 is only one example of a system that may incorporate an embodiment of the invention. In some other embodiments, system 1000 may have more or fewer components than shown in FIG. 10, may combine two or more components, or may have a different configuration or arrangement of components. In some embodiments, system 1000 may be part of a portable communications device, such as a mobile telephone, a smart phone, or a multifunction device. Exemplary embodiments of portable devices include, without limitation, the iPhone®, iPod Touch®, and iPad® devices from Apple Inc. of Cupertino, Calif. In some other embodiments, system 1000 may also be incorporated in other devices such as desktop computers, kiosks, and the like.

I/O subsystem 1006 provides an interface that allows a user to interact with system 1000. I/O subsystem 1006 may output information to the user. For example, I/O subsystem 1006 may include a display device such as a monitor or a screen. I/O subsystem 1006 may also enable the user to provide inputs to system 1000. In some embodiments, I/O subsystem 1006 may include a touch-sensitive interface (also sometimes referred to as a touch screen) that can both display information to a user and also receive inputs from the user. For example, in some embodiments, I/O subsystem 1006 may display a software keyboard and enable a user to provide input using the software keyboard such as by selecting a dynamic character key. In some other embodiments, I/O subsystem 1006 may include one or more input devices that allow a user to provide inputs to system 1000 such as, without limitation, a mouse, a pointer, a keyboard, or other input device.

Memory 1026 may be configured to store data and instructions used by some embodiments of the invention. In some embodiments, memory 1026 may include volatile memory such as random access memory or RAM (sometimes referred to as system memory). Instructions or code or programs that are executed by one or more processors of system 1000 may be stored in the RAM. Memory 1026 may also include non-volatile memory such as one or more storage disks or devices, flash memory, or other non-volatile memory devices.

In some embodiments, character selection subsystem 1002 and keyboard subsystem 1004, working in cooperation, are responsible for performing processing related to providing a software keyboard with a dynamic character key, where a character associated with dynamic character key is automatically and intelligently deter based upon the context, as discussed in this disclosure. In one embodiment, keyboard subsystem 1004 is configured to handle all processing related to displaying a software keyboard 1008 and receiving input provided using the software keyboard. In some embodiments, software keyboard 1008 may be a language-specific keyboard, such as a French language keyboard (e.g., software keyboard 104 depicted in FIGS. 1-9). Software keyboard 11008 rendered by keyboard subsystem 1004 may include multiple keys 1010 including a dynamic character key 1012. A character may be associated with dynamic character key 10112. The character associated with dynamic character key 1012 may be displayed on the key. For example, in FIG. 10, a diacritical mark grave accent (´) is displayed on key 10112 in FIG. 10 indicating that the grave accent (´) is currently associated with dynamic character key 1012.

Keyboard subsystem 1004 is configured to receive inputs corresponding to keys of software keyboard 1008 selected by a user. Keyboard subsystem 1004 may provide the inputs to character selection subsystem 1002. Character selection subsystem 1002 may use these inputs to select a character to be associated with dynamic character key 1012. In some embodiments, the input information may be stored in memory 1026 as information 1030. Character selection subsystem 1002 may then access information 1030 from memory 1026 as part of its processing for selecting a character to be associated with dynamic character key 11012. Keyboard subsystem 1004 may also provide the input information to application 1018 (e.g., Notes application depicted in FIGS. 1-9). Application 1018 may then display the input information in a text display area 1016 associated with application 1018 and displayed by I/O subsystem 1006 (e.g., the input information is displayed in user interface area 102 in FIGS. 1-9).

As described above, in some embodiments, the character that is selected to be associated with the dynamic character key may be a non-alphanumeric character such as a diacritical mark or a punctuation mark. The non-alphanumeric characters from which the character to be associated with the dynamic character key is selected may include without limitation one or more diacritical marks provided by a language, punctuations provided by a language, and the like.

In the embodiment depicted in FIG. 10, character selection subsystem 1002 comprises a language determinator module 1020 and a character selector module 1024. These modules may be implemented in software, in hardware, or combinations thereof. In some embodiments, character selection subsystem 1002 may have more or less components than those depicted in FIG. 10.

In some embodiments, language determinator 1020 is configured to determine the language to be used for performing the character selection processing. This is because, in many instances, the character that is selected to be associated with the dynamic character key may depend upon the language being used. The set of characters from which the character to be associated with the dynamic character key is chosen may depend upon the language being used. For example, different languages provide for different sets of diacritical marks. For example, the set of diacritical marks provided by French is different from the set of diacritical marks provided by Czech, with some overlap. Further, given a particular set of characters for a language from which to select, the particular character that is selected may depend upon usage rules specific to that language. Accordingly, a language determinator 1020 is provided that is configured to determine the language to be used for the analysis.

Language determinator 1020 may employ various different techniques to determine the language to be used. In one embodiment, the language associated with the currently loaded software keyboard may be identified as the language to be used. In another embodiment, a user-configurable language option may be provided that indicates the language to be used. In yet another embodiment, the application that is being executed by the device may indicate a language preference. In some embodiments, keyboard subsystem 1004 may inform language determinator 1020 about the language to be used. In yet other embodiments, language determinator 1020 may be configured to analyze the input information received from keyboard subsystem 1004 and determine the language. A default language may also be configured. Accordingly, language determinator 1020 may use various different ways or combinations thereof to determine the language to be used for the character selection analysis.

In some embodiments, once a language has been determined, language determinator module 1020 may be configured to access and load into memory 1026 reference information 1028 related to the determined language. This reference information 1028 is then used by character selector 1024 for selecting a character to be associated with the dynamic character key.

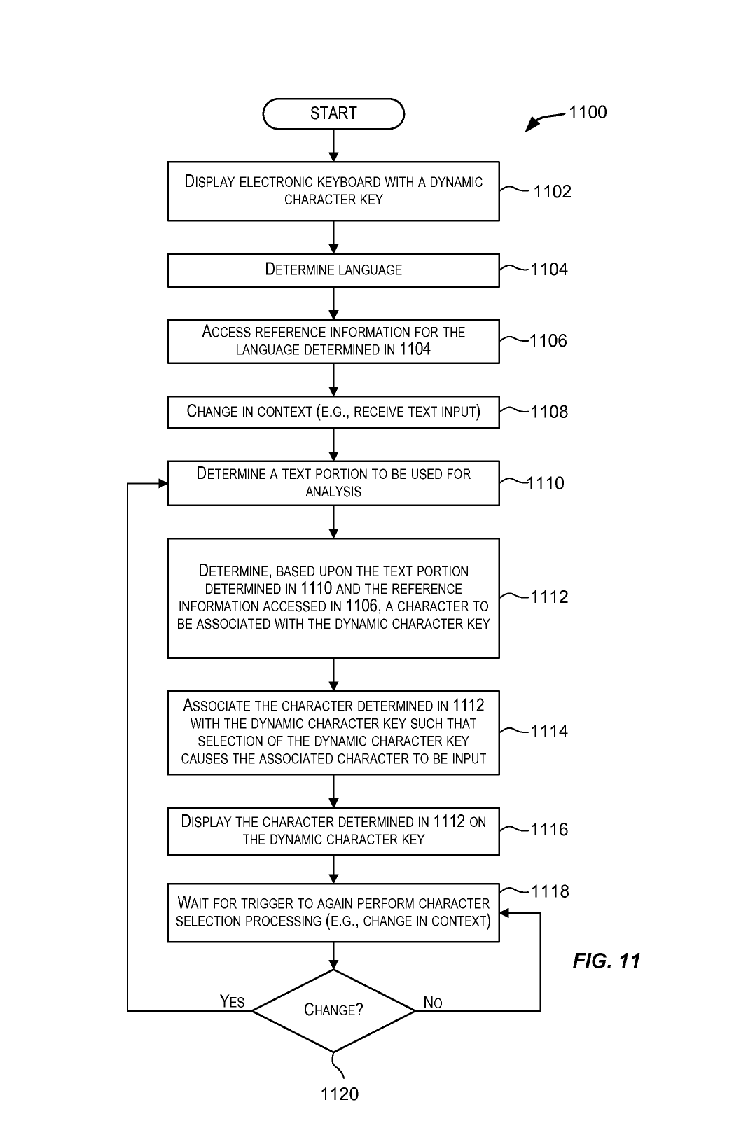

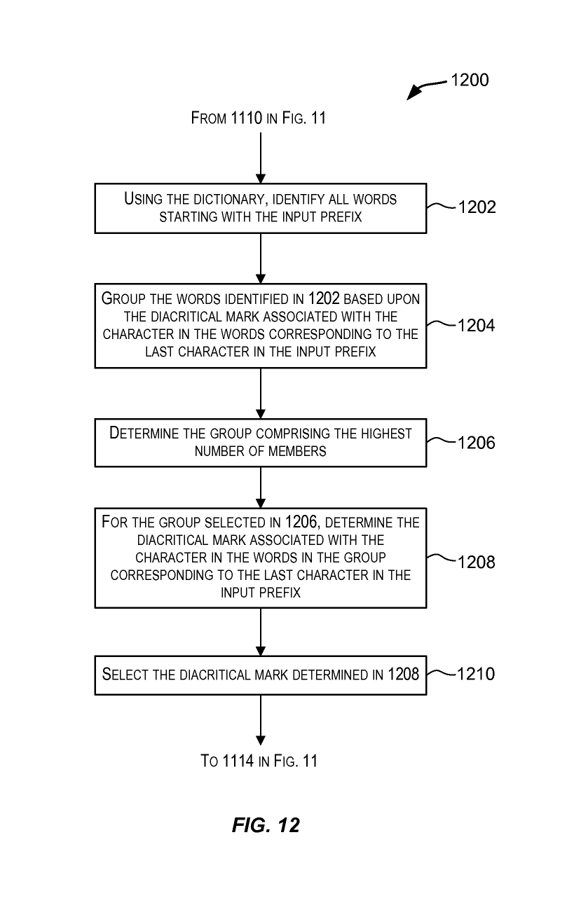

Character selector module 1024 is configured to perform processing to determine a character, from among multiple characters, to be associated with dynamic character key 1012. In some embodiments, as part of this processing, character selector module 1024 is configured to determine a current context and, based upon the current context and reference information 1028, determine a character to be associated with dynamic character key 1012 on software keyboard 1008. In some embodiments, the character that is associated with dynamic character key 1012 is chosen from a set of non-alphanumeric characters. Character selector 1024 is configured to track changes in the context and perform processing responsive to these changes to dynamically determine and change the character associated with dynamic character key 1012. Further details related to processing performed for selecting a character to be associated with the dynamic character key are described below with reference to FIGS. 11 and 12.

In some embodiments, character selection subsystem 1002 is configured to convey information regarding the selected character to keyboard subsystem 1004. Keyboard subsystem 1004 is configured to associate the selected character with dynamic character key 1012 such that selection of dynamic character key 1012 causes the associated character to be input. Keyboard subsystem 1004 is also configured to display the currently associated character on dynamic character key 1012. Character selection subsystem 1002 may also provide information identifying a default character to be associated with dynamic character key 1012 to keyboard subsystem 1004.

When a user selects dynamic character key 1012, for example, by hitting dynamic character key 1012 while typing, the associated character is input and provided to keyboard subsystem 1004. Different actions may be performed based upon the input character. For example, if the input character is a diacritical mark, then the character immediately preceding the cursor may be modified using the input diacritical mark to generate a diacritical character. Keyboard subsystem 1004 may provide the diacritical character to application 1018, which may then display the diacritical character in area 1016. In some other embodiment, keyboard subsystem 1004 may provide the input diacritical mark to application 1018, which may then be configured to determine the diacritical character resulting from the input and to display the diacritical character in area 1016 of the application.

In some other embodiments, if the character input upon selection of the dynamic character key is a punctuation, keyboard system 1004 may provide the punctuation to application 1018, which may insert and display the punctuation at the cursor position.

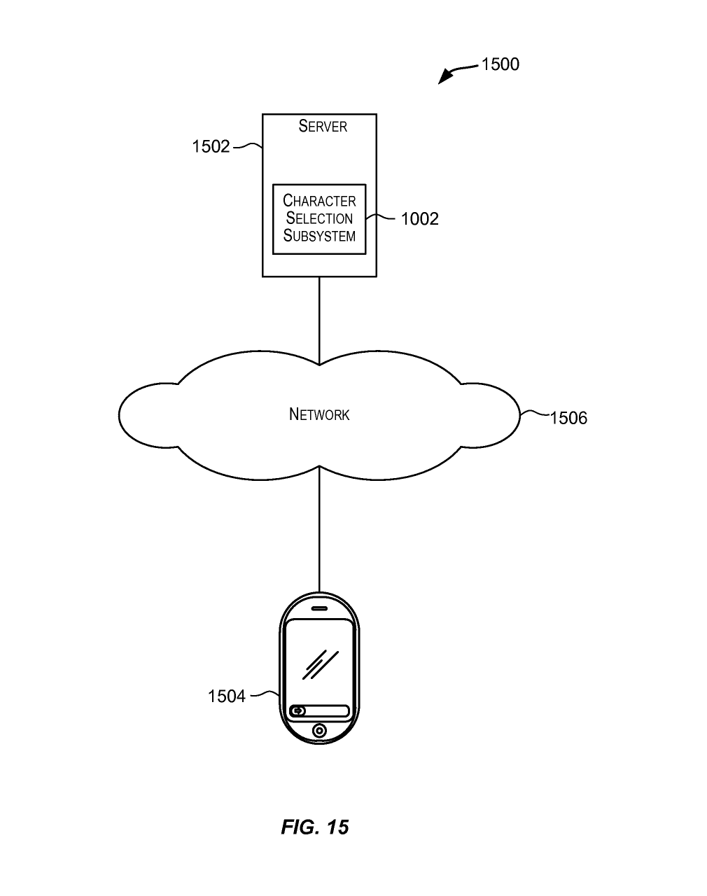

System 1000 depicted in FIG. 10 may be provided in various configurations. In some embodiments, system 1000 may be configured as a distributed system where one or more components of system 1000 are distributed across one or more networks in the cloud. FIG. 15 depicts a simplified diagram of a distributed system 1500 for providing a software keyboard with a dynamic character key according to some embodiments. In the embodiment depicted in FIG. 15, character selection subsystem 1002 is provided on a server 1502 that is communicatively coupled with a remote client device 1504 via network 1506.

Network 1506 may include one or more communication networks, which could be the Internet, a local area network (LAN), a wide area network (WAN), a wireless or wired network, an Intranet, a private network, a public network, a switched network, or any other suitable communication network. Network 1506 may include many interconnected systems and communication links including but not restricted to hardwire links, optical links, satellite or other wireless communications links, wave propagation links, or any other ways for communication of information. Various communication protocols may be used to facilitate communication of information via network 1506, including but not restricted to TCP/IP, HTTP protocols, extensible markup language (XML), wireless application protocol (WAP), protocols under development by industry standard organizations, vendor-specific protocols, customized protocols, and others.

In the configuration depicted in FIG. 5, the software keyboard including a dynamic character key may be displayed by client device 1504. A user of client device 1504 may use the software keyboard to provide inputs including inputting characters using the dynamic character key. In one such embodiment, information input using client device 1504 may be communicated to server 1502 via network 1506. Character selection subsystem 1002 on server 1502 may then determine a character to be associated with the dynamic character key displayed by client device 1504. Information identifying the selected character may then be communicated to client device 1504. A keyboard subsystem on client device 1504 may then associate the selected character with the dynamic character key and also display the selected character on the dynamic character key.

In the configuration depicted in FIG. 15, character selection subsystem 1002 is remotely located from client device 1504. In some embodiments, server 1502 may provide character selection services to multiple clients. The multiple clients may be served concurrently or in some serialized manner. In some embodiments, the services provided by server 1502 may be offered as web-based or cloud services or under a Software as a Service (SaaS) model.

It should be appreciated that various different distributed system configurations are possible, which may be different from distributed system 1500 depicted in FIG. 15. The embodiment shown in FIG. 15 is thus only one example of a distributed system for providing a software keyboard with a dynamic character key and is not intended to be limiting.

FIG. 11 depicts a simplified flowchart 1100 depicting a method for dynamically selecting a character and associating the selected character with a dynamic character key on a software keyboard according to some embodiments. The processing depicted in FIG. 11 may be implemented in software (e.g., code, instructions, program) executed by one or more processors, hardware, or combinations thereof. The software may be stored on a non-transitory computer-readable storage medium. The particular series of processing steps depicted in FIG. 11 is not intended to be limiting.

As depicted in FIG. 11, at 1102, a software keyboard may be displayed comprising a dynamic character key. In some embodiments, when the software keyboard is first displayed, a default character may be associated with the dynamic character key. However, it is not required that a default character be associated with the dynamic character key when the software keyboard is first displayed.

At 1104, a language that is to be used for the analysis is identified. Different languages may provide different sets of characters from which the character to be associated with the dynamic character key is to be chosen. Further, the manner in which certain characters are used, such as diacritical marks and punctuations, may vary from one language to another. Accordingly, in some embodiments, identifying a language provides a basis for identifying the set of characters that are candidates for being associated with the dynamic character key and for identifying the usage rules to be used for selecting a particular character from the set.

As previously indicated, various different techniques may be used to determine the language in 1104. According to one technique, the language associated with the currently loaded software keyboard may be identified as the language to be used. For example, if a French software keyboard is loaded, then French is identified as the language to be used in 1104. In some embodiments, a user may specify the language to be used. For example, a user may seta language setting identifying the language. In some instances, the application that is being executed by the device may identify the language. In some other embodiments, other contextual information related to the application may be used to determine the language. In some embodiments, if some input information has already been provided, then that input information may be analyzed to determine the language being used. In yet other embodiments, information identifying the location of the device (e.g., GPS information) may be used to determine the language. For example, if the location of the device is determined to be in France, then French may be identified as the language. In some embodiments, a default language may be used. Various other techniques including combinations of different techniques may be used to determine the language in 1104.

At 1106, reference information for the language determined in 1104 is accessed. In some embodiments, the reference information may be loaded into a memory (e.g., RAM) associated with a processor configured to perform character selection-related processing. The reference information for a language may be provided in various different forms. In some embodiments, the reference information for a language may comprise a set of rules identifying the characters to be used for selecting a character to be associated with the dynamic character key. For example, in some embodiments, the set of rules may identify the multiple diacritical marks or punctuations provided by the language and rules for their usage. In some other embodiments, the reference information for a language may comprise a list of words in the language, for example, words that include diacritical characters. For example, in one embodiment, the reference information for a language may be a dictionary for the language. In yet other embodiments, the reference information for a language may be a lookup table, wherein the result of the lookup operation identifies the character to be selected and associated with the dynamic character key. In yet other embodiments, the reference information for a language may be configured by a user or may be provided by an application.

At 1108, a change in context is detected and processing triggered to select a character to be associated with the dynamic character key. A change in context may happen due to various reasons. For example, receiving input text information may cause a change in context. This is illustrated in the example depicted in FIGS. 1 and 2—when the user inputs the text “A” there is a change in context. As a user continues to type using a software keyboard, each typed character may represent a change in context.

As another example, a change in context may also occur when the position of the cursor used for text input is changed. For example, consider a situation where the text “creme brulee” has already been input and the current cursor position is at the end of the word “brulee”. 11 the cursor position is changed to a different position within the phrase “creme brulee”, then this may represent a change in the context. A change in the position of the cursor may thus represent a change in context.

Upon detecting a change in context in 1108, at 1110, a text portion to be used for selecting the character to be associated with the dynamic character key is determined. In some embodiments, the text portion is determined based upon the position of the cursor, which identifies a location where the next character input will be inserted.

The text portion that is selected in 1110 may depend upon the context. The reference information that is used for selecting the character to be associated with the dynamic character key may also influence the text portion that is selected. For example, in some embodiments, the text portion that is used is a portion of text immediately preceding the cursor. This text portion is then input to the character-selection processing. The text portion that is used is thus also referred to as an input prefix. For example, in the example depicted in FIG. 2, the input prefix determined in 1110 is “A”. As another example, in the example depicted in FIG. 4, the input prefix determined in 1110 may be “Gou”. As yet another example, if the input text is “creme brulee” and the cursor is at the end of the word “brulee”, then the input prefix determined in 1110 may be “brulee”. If however, the cursor position was changed to after the character ‘u’ in the word “brulee”, then the input prefix determined in 1110 may be “bru”.

In other alternative embodiments, other text portions including one or more characters, words, or even sentences may be determined and used for selecting the character to be associated with the dynamic character key. For example, for processing related to a hyphen (example provided below), the text portion that is selected may include both one or more characters in front of the cursor and one or more characters behind the cursor.

At 1112, a single character to be associated with the dynamic character key is determined based upon the text portion determined in 1110 and the reference information accessed in 1106. The processing performed in 1112 may depend upon the type of reference information being used. An example of processing that may be performed in 1112 if the reference information is a dictionary is described below with reference to FIG. 12. An example of processing that may be performed in 1112 if the reference information is a set of rules is described below using the French language as an example. The processing in 1112 results in a single character being selected to be associated with the dynamic character key. In some embodiments, the processing performed in 1112 selects a character from a set of non-alphanumeric characters including diacritical marks and punctuations.

At 1114, the character determined in 1112 is associated with the dynamic character key. The association in 1114 causes the character selected in 1112 to be input when the dynamic character key is selected. As a result of the association in 1114 between the character selected in 1112 and the dynamic character key, any previous associations with the dynamic character key are overwritten or broken. Accordingly, if a first character was previously associated with the dynamic character key, then after the processing in 1114, a new character is selected in 1112 and is associated with the dynamic character key instead of the first character.

At 1116, the character determined in 1112 is displayed on the dynamic character key. In this manner, the information displayed on the dynamic character key is updated to display the character that is currently associated with the dynamic character key. This enables the user of the software keyboard to easily identify the character mark that is currently associated with the dynamic character key.

At 1118 and 1120, a monitoring phase may be entered. In this phase, a signal may be monitored for that causes the character selection analysis to be performed again. For example, in some embodiments, in 1118 and 1120, a change in context may be monitored. Upon determining in 1120 that the context has changed, processing may continue with 1110 wherein another text portion for selecting a character to be associated with the dynamic character key is identified and processing continues with 1112, 1114, 1116, and eventually back to 1118. In this manner, a change in context is dynamically monitored. Whenever a change in context is detected, the processing is performed and a character dynamically selected and associated with the dynamic character key and the display on the dynamic character key is dynamically updated to reflect the changed association. As previously discussed, various different conditions (e.g., receive additional input text, change in cursor position, etc.) may cause a change in context.

As described above, in 1110, a text portion is determined for performing processing related to selection of a character to be associated with the dynamic character key. In some, embodiments, multiple text portions may be determined in 1110, and processing in 1112 may be performed for each of the text portions. A single character may then be selected based upon the processing for the multiple text portions and associated with the dynamic character key.

As indicated above, the reference information that is used for selecting a character to be associated with the dynamic character key may be provided in different forms. In some embodiments, a language specific set of rules may be provided and used to select the character. For example, in one embodiment, the rules shown below may be provided for the French language. For purposes of this example, it is assumed that the “input prefix” is a text portion immediately preceding the cursor position. For example, if the input text is “creme brulee” and the cursor lies between the ‘u’ and the ‘l’ in “brulee”, then the input prefix is “bru”.

For French:
Rule 1: If the input prefix is one of “aujourd”, “c”, “d”, “entr”, “j”, “l”, “m”, “n”, “prud”, “s”, “t”, “y”, or if it ends in “qu”, then select the apostrophe ('). (Explanation: These prefixes are known to precede the apostrophe in French words.)
Rule 2: If the input prefix begins with ‘a’, select the grave accent (`).
Rule 3: If the input prefix begins with ‘e’, select the acute accent (´).
Rule 4: If the input prefix ends with ‘i’ or ‘o’, select the circumflex (̂).
Rule 5: Utile input prefix ends with ‘u’, select the circumflex (̂), unless the input prefix is “ou” or “dou”, in which case, select the grave accent (´).
(Explanation for Rules 2-5: Each of these accents is statistically the most common accent to appear on top of the corresponding letter in French. The “au” special case treats the common French word “où” (where) and the related word “d'où” (from where)
Rule 6: If none of the above Rules apply, then select the acute accent (´), but display a popup with the grave accent (`), circumflex (̂), and umlaut (\ddot{}) (also referred to as dieresis) accents when the dynamic character key is long-pressed.

Given the above rules, as part of the processing performed in 1112, the rules are applied to the input prefix to determine a character, which may be a punctuation or a diacritical mark, to be associated with the dynamic character key. If none of Rules 1-5 apply, then per Rule 6, the acute accent (´) is selected and associated with the dynamic character key and the acute accent (´) displayed on the dynamic character key. When Rule 6 is applicable, in some embodiments, a long-press on the dynamic character key may cause a popup menu (like popup menu 902 in FIG. 9) to be displayed with grave accent (`), circumflex (̂), and umlaut (\ddot{}) provided as user-selectable options. In this manner, if the user does not want to select the character associated with the dynamic character key, the user is still provided an option to select an alternative character for a list provided by the popup menu.

Different rule sets may be provided for different languages. For example, the Czech language provides three diacritical marks, namely, the acute accent (´), the caron (\check{}) (also referred to as the há\ddot{c}ek), and the ring ( [symbol] ). The Czech language includes the following diacritical characters: á, é, í, ó, ú, ý, \check{c}, d', \check{e}, \check{n}, \check{r}, \check{s}, t', \check{z}, and [symbol] . Assuming that the “input prefix” is a text portion immediately preceding the cursor position and ending at the character immediately preceding the cursor position, a set of rules may be provided for the Czech language as follows:
Rule 1: Select the caron accent if the input prefix ends in any of c, d, n, r, s, t, or z, else, always select the acute accent (´) unless the input prefix ends in ‘u’ and is longer than one letter (i.e., the cursor follows a non-word-initial ‘u’), in which case select the ring-above ( [symbol] ) accent. (Explanation: This is because [symbol] is much more common than ú in the non-word-initial position in Czech.)

In some embodiments, the reference information may be a lookup table. For example, one such lookup table may be provided for the Portugese language. The Portugese language provides for the following diacritical characters: à, á, â, ã, ç, é, ê, í, \check{o}, ô, õ, ú. In one embodiment, the table may be created by compiling a table of consonant-vowel-accent combinations and their respective frequencies in the Portuguese language. So, for example, this table identifies how often the strings “bá”, “bã”, “bâ” occur in the Portuguese language, and also “bé”, “b\tilde{e}”, “bê”, “cá”, “cã”, “câ”, and so on. Then, when the user types an input prefix ending in a vowel, this table is looked up to determine what accent is most likely given that vowel and the preceding consonant.

As indicated above, in some embodiments, the reference information may be a list of words, such as a dictionary. FIG. 12 depicts a simplified flowchart 1200 depicting a method for using a dictionary (or any list of words) to select a diacritical mark according to some embodiments. For the processing depicted in FIG. 2, it is assumed that the set of characters, from which a particular character is selected to be associated with the dynamic character key, is a set of diacritical marks provided by the language being used. The processing depicted in FIG. 12 may be implemented in software (e.g., code, instructions, program) executed by one or more processors, hardware, or combinations thereof. The software may be stored on a non-transitory computer-readable storage medium. The particular series of processing steps depicted in FIG. 12 is not intended to be limiting. It is assumed that the input prefix is a text portion immediately preceding the cursor position (ending at the character immediately preceding the cursor position).

At 1202, all words in the dictionary starting with the input prefix are determined. For purposes of identifying words from the dictionary in 1202, any diacritical marks associated with the character in the words corresponding to the character immediately preceding the cursor position (i.e., the last character in the input prefix) are ignored. For example, if the input prefix is “ou” and a French dictionary is used, then all words starting with “oú”, “oû”, and “oü” are identified.

At 1204, the words identified in 1202 are grouped based upon the diacritical mark associated with the character in the words corresponding to the last character in the input prefix, i.e., corresponding to the character in the input prefix immediately preceding the cursor position. For example, for words determined for input prefix “ou”, all words starting with “oú” are grouped into a first group, words starting with “oû” are grouped into a second group, words starting with “oü” are grouped into a third group, and so on.

At 1206, the group with the highest number of members is determined. For the group selected in 1206, at 1208, the diacritical mark associated with the character in the words in the group corresponding to the last character in the input prefix is determined. The diacritical mark determined in 1208 is then selected in 1210 as the diacritical mark to be associated with the dynamic character key. For example, if the group comprising words starting with “oú” is determined to have the highest number of members (i.e., highest frequency), then the acute accent (´) is selected as the diacritical mark to be associated with the dynamic character key. Grouping the words in 1204 and then determining the group with the highest number of members effectively determines the diacritical mark with the highest aggregate frequency. It is possible that only one group is formed in 1204. This single group then represents the group with the highest number of members and the associated diacritical mark is selected. Processing then continues with 1114 in FIG. 11 wherein the selected diacritical mark is associated with the dynamic character key.

In some embodiments, in addition to associating the diacritical mark corresponding to the group with the highest number of members with the dynamic character key, the diacritical marks associated with the top “N” groups with the highest number of members may be selected and included in the menu (e.g., menu 902 in FIG. 9) that is displayed when the user performs a long-press on the dynamic character key. This enables the user to not only input the diacritical mark associated with the dynamic character key by selecting the dynamic character key, but also to see other diacritical mark options via the menu.

In some embodiments, a set of rules may be used in combination with a list of words (e.g., a dictionary) to select a character to be associated with the dynamic character key.

The character that is associated with the dynamic character key can be a printable or a non-printable character. For example, under the appropriate context, a space character may be associated with the dynamic character key. For example, consider a situation where the user has typed in “Howare you”. When the cursor is placed between the ‘w’ and ‘a’ in “Howare”, contextual processing may be triggered and may determine that a space is missing. Accordingly, a space may be selected and associated with the dynamic character key. A representation of the space character may also be displayed on the dynamic character key. For example, in one embodiment, the word “space” may be displayed on the dynamic character key. In this example, the text portion that is selected for selection of the character to be associated with the dynamic character key instance may be “Howare”, which includes characters in front of the cursor and also characters after the cursor. The reference information that is used for this example may be a dictionary of words for the language (e.g., an English dictionary for this example). The processing may determine that the text portion “Howare” can be parsed into two separate valid words “how” and “are” (e.g., using trigram model analysis) and a space character may accordingly be selected to be associated with the dynamic character key. If the user hits the dynamic character key when the space is associated with the dynamic character key, the space character is input and “Howare you” becomes “How are you”.

In the “Howare you” example, after the user has entered the space (i.e., the text is now “How are you”), when the cursor is placed at the end of sentence after the letter ‘u’ in “you”), contextual character processing may be triggered and may dynamically select and associate a question mark ‘?’ with the dynamic character key. In this case, the text portion that is selected for analysis may be the sentence “How are you”. Reference information that is used for the processing may include grammar and semantic rules for the English language including rules for the usage of a question mark. Contextual processing may determine that the question mark is the likely character to be input after “How are you” and the ‘?’ may thus be selected and associated with the dynamic character key.

As another example, a hyphen (‘-’) may be associated with the dynamic character key on a software keyboard for a particular context. For example, consider a situation where the user has typed in “maneating shark”. When the cursor is placed between the ‘n’ and ‘e’ in “maneating”, the contextual processing may be triggered and may determine that a hyphen (‘-’) is missing. Accordingly, a hyphen may be selected and associated with the dynamic character key. A ‘-’ may be displayed on the dynamic character key. In this example, the text portion that is selected for the processing may be “maneating”, which includes characters both in front of and after the cursor. The reference information that is used for the processing may be a list of hyphenated words including “maneating”. If the user hits the dynamic character key when the hyphen is associated with it, the hyphen is input and “maneating” becomes “man-eating”. In some embodiments, information that is used for the auto-complete function (e.g., information mapping an input word to a target word that is to replace the input word) may be used as reference information for selecting a character to be associated with the dynamic character key.

As yet another example, consider a situation where the user has typed in “Janets house”. When the cursor is placed between the ‘t’ and ‘s’ in “Janets”, contextual processing may be triggered and may select and associate an apostrophe (') with the dynamic character key. An apostrophe may be displayed on the dynamic character key. In this example, the text portion that is selected for the processing may be “Janets”, which includes characters both in front of and behind the cursor. Grammar information related to use of the apostrophe in the English language may be used as reference information for this processing. If the user hits the dynamic character key when the apostrophe is associated with it, the apostrophe is input and “Janets” becomes “Janet's”.

As described above, embodiments of the present invention provide a software keyboard with a dynamic character key whose associated character is dynamically and intelligently changed based upon the context. Such a mutable key significantly simplifies the typing experience by making it easier for a user to input characters, especially non-alphanumeric characters such as diacritical marks and punctuations. In certain embodiments, the character that is associated with the dynamic character key is one that is the most likely to be input by the user given the current cursor position. For example, the associated character may be one that is most likely to be input from a spelling perspective or from a grammatical perspective. The user can then simply hit or select the dynamic character key to input the character associated with the dynamic character key.

For example, for a particular context, a diacritical mark may be selected and associated with the dynamic character key. In such a situation, a user can simply hit the dynamic character key and the associated diacritical mark is automatically input and used to modify a character to generate a diacritical character. This significantly increases the user's typing speed for entering diacritical characters and in turn enhances the user's typing experience. The user is no longer forced to remember key combinations or special commands/menus for inputting diacritical characters. As another example, a punctuation mark may be associated with the dynamic character key for a particular context based upon the cursor position. The punctuation associated with the dynamic character key may be a punctuation mark that is most likely to be input (for example, using the grammar rules for a language) given the cursor position. By dynamically associating a character such as a diacritical mark or a punctuation mark with the dynamic character key based upon the context, the dynamic character key assists the user in typing text that is correctly spelled and also grammatically and syntactically correct.

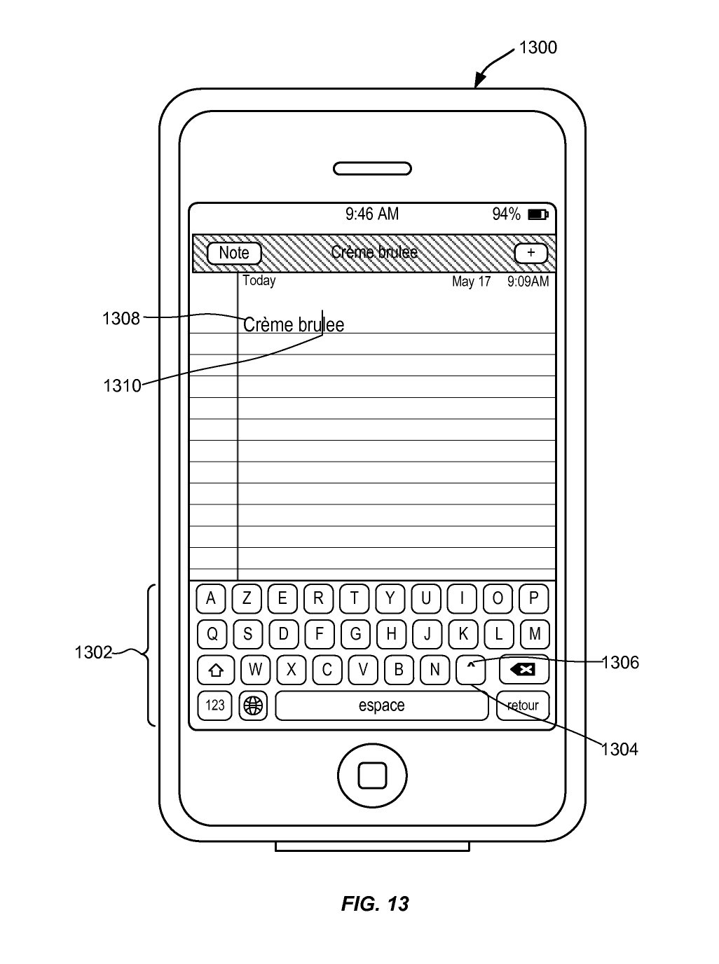

FIG. 13 depicts an example of a software keyboard displayed by an iPhone® device from Apple Inc. of Cupertino, Calif., that provides a software keyboard with a dynamic character key according to some embodiments. A French software keyboard 1302 is displayed overlaid over a Notes application user interface. Software keyboard 1302 comprises multiple keys including a dynamic character key 1304. In the example depicted in FIG. 13, the phrase “crème brulee” 1308 has been entered and the cursor 1310 is positioned between the letters ‘u’ and in the word “brulee”. In some embodiments, the text portion used for character selection analysis is “bru” based upon the position of cursor 1310. Using this input prefix and reference information, the circumflex (̂) is selected as the character that is associated with dynamic character key 1304. The circumflex (̂) is also displayed on dynamic character key 1304. If the user were to change the position of cursor 1310, which in turn changes the input prefix, the character selection processing may be triggered and a different character may possibly be selected to be associated with dynamic character key 1304.

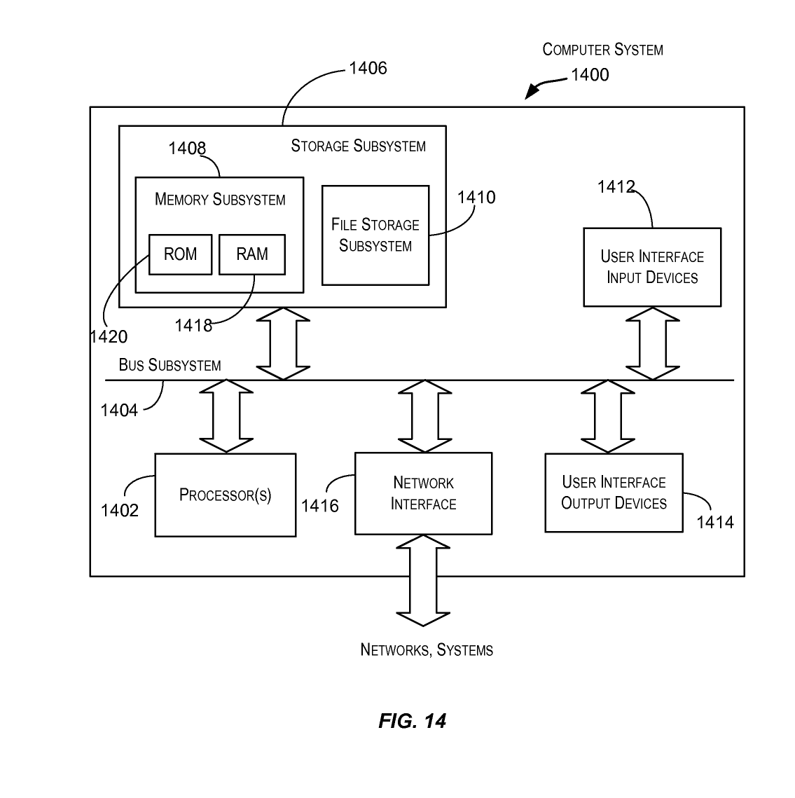

System 1000 depicted in FIG. 10 may be incorporated into various systems and devices. FIG. 14 is a simplified block diagram of a computer system 1400 that may incorporate components of system 100 according to some embodiments. As shown in FIG. 14, computer system 1400 includes one or more processors 1402 that communicate with a number of peripheral subsystems via a bus subsystem 1404. These peripheral subsystems may include a storage subsystem 1406, including a memory subsystem 1408 and a file storage subsystem 1410, user interface input devices 1412, user interface output devices 1414, and a network interface subsystem 1416.

Bus subsystem 1404 provides a mechanism for letting the various components and subsystems of computer system 1400 communicate with each other as intended. Although bus subsystem 1404 is shown schematically as a single bus, alternative embodiments of the bus subsystem may utilize multiple busses.

Processor 1402, which can be implemented as one or more integrated circuits e.g., a conventional microprocessor, or microcontroller), controls the operation of computer system 1400. One or more processors 1402 may be provided. These processors may include single core or multicore processors. In various embodiments, processor 1402 can execute a variety of programs in response to program code and can maintain multiple concurrently executing programs or processes. At any given time, some or all of the program code to be executed can be resident in processor(s) 1402 and/or in storage subsystem 1406. Through suitable programming, processor(s) 1402 can provide various functionalities described above.

Network interface subsystem 1416 provides an interface to other computer systems and networks. Network interface subsystem 1416 serves as an interface for receiving data from and transmitting data to other systems from computer system 1400. For example, network interface subsystem 1416 may enable computer system 1400 to connect to one or more devices via the Internet. In some embodiments network interface 1416 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1416 can provide wired network connectivity (e.g., Ethernet) in addition to or instead of a wireless interface.

User interface input devices 1412 may include a keyboard, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices and mechanisms for inputting information to computer system 1400. For example, in an iPhone®, user input devices 1412 may include one or more buttons provided by the iPhone®, a touch screen, which may display a software keyboard, and the like. The software keyboard may include a dynamic character key where a character associated with the dynamic character key can be dynamically changed based upon the context.

User interface output devices 1414 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1400. For example, a software keyboard may be displayed using a fiat-panel screen.

Storage subsystem 1406 provides a computer-readable storage medium for storing the basic programming and data constructs that provide the functionality of some embodiments. Storage subsystem 1406 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1406. These software modules or instructions may be executed by processor(s) 1402. Storage subsystem 1406 may also provide a repository for storing data used in accordance with the present invention. Storage subsystem 1406 may include memory subsystem 1408 and file/disk storage subsystem 1410.

Memory subsystem 1408 may include a number of memories including a main random access memory (RAM) 1418 for storage of instructions and data during program execution and a read only memory (ROM) 1420 in which fixed instructions are stored. File storage subsystem 1410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like memory storage media.

Computer system 1400 can be of various types including a personal computer, a portable device (e.g., an iPhone®, an iPad®), a workstation, it network computer, a mainframe, a kiosk, a server or any other data processing system. Due to the ever-changing nature of computers and networks, the description of computer system 1400 depicted in FIG. 14 is intended only as a specific example. Many other configurations having more or fewer components than the system depicted in FIG. 14 are possible.

Various embodiments described above can be realized using any combination of dedicated components and/or programmable processors and/or other programmable devices. The various embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting.

Thus, although specific invention embodiments have been described, these are not intended to be limiting. Various modifications and equivalents are within the scope of the following claims.

What is claimed is:

1. A computer-readable memory storing a plurality of instructions for controlling one or more processors, the plurality of instructions comprising:
instructions that cause at least one processor from the one or more processors to cause a software keyboard comprising a plurality of keys to be displayed by a computing device, the plurality of keys including a first key;
instructions that cause at least one processor from the one or more processors to determine a text portion to be used for selecting a character to be associated with the first key;
instructions that cause at least one processor from the one or more processors to determine, based upon the text portion and reference information for a language, a first character to be associated with the first key from a plurality of characters;
instructions that cause at least one processor from the one or more processors to associate the first character with the first key such that selection of the first key causes the first character to be input to the computing device; and
instructions that cause at least one processor from the one or more processors to cause the first character to be displayed on the first key of the software keyboard.

2. The computer-readable memory of claim 1 wherein the plurality of characters comprises non-alphanumeric characters.

3. The computer-readable memory of claim 2 wherein the first character is a diacritical mark or a punctuation mark.

4. The computer-readable memory of claim 1, wherein the plurality of instructions further comprises:
instructions that cause at least one processor from the one or more processors to determine a second character from the plurality of characters to be associated with the first key instead of the first character, the second character being different from the first character;
instructions that cause at least one processor from the one or more processors to change the character associated with the first key from the first character to the second character such that selection of the first key causes the second character to be input to the computing device; and
instructions that cause at least one processor from the one or more processors to cause the second character to be displayed on the first key instead of the first character.

5. The computer-readable memory of claim 1 wherein:
the reference information is a set of rules for the language;
the instructions that cause at least one processor from the one or more processors to determine the text portion comprise instructions that cause at least one processor from the one or more processors to determine the text portion based upon a cursor position; and
the instructions that cause at least one processor from the one or more processors to determine the first character comprise instructions that cause at least one processor from the one or more processors to determine the first character by applying one or more rules from the set of rules to the text portion.

6. The computer-readable memory of claim 1 wherein:
the reference information is a list of words for the language; and
the instructions that cause at least one processor from the one or more processors to determine the text portion comprise instructions that cause at least one processor from the one or more processors to determine the text portion based upon a cursor position; and
the instructions that cause at least one processor from the one or more processors to determine the first character comprise:
instructions that cause at least one processor from the one or more processors to identify a set of one or more words from the list of words based upon the text portion; and
instructions that cause at least one processor from the one or more processors to determine the first character based upon the set of one or more words.

7. The computer-readable memory of claim 1 wherein:
the instructions that cause at least one processor from the one or more processors to determine the text portion comprise instructions that cause at least one processor from the one or more processors to determine a text portion based upon a cursor position.

8. The computer-readable memory of claim 1, wherein the plurality of instructions further comprises:
instructions that cause at least one processor from the one or more processors to receive, after the first character is associated with the first key, a signal indicating a long press of the first key; and
instructions that cause at least one processor from the one or more processors to, responsive to the signal, cause a popup menu to be displayed comprising the first character, the first character being selectable from the popup menu.

9. The computer-readable memory of claim 1 wherein:
the language is French; and
the plurality of characters comprises an acute accent (´), a grave accent (`), a circumflex (̂), umlaut (\ddot{}), a cedilla ( [symbol] ), and an apostrophe (').

10. The computer-readable memory of claim 1, wherein the plurality of instructions comprises:
instructions that cause at least one processor from the one or more processors to receive, after the first character is associated with the first key, a signal indicating selection of the first key; and
instructions that cause at least one processor from the one or more processors to, responsive to receiving the signal:
identify a character immediately preceding a cursor; and
modify the character using the first character.

11. A computer-readable memory storing a plurality of instructions for controlling one or more processors, the plurality of instructions comprising:
instructions that cause at least one processor from the one or more processors to cause a software keyboard comprising a plurality of keys to be displayed by a computing device, the plurality of keys comprising a first key associated with a first character from a plurality of characters;
instructions that cause at least one processor from the one or more processors to determine a second character from the plurality of characters to be associated with the first key instead of the first character, the second character being different from the first character;
instructions that cause at least one processor from the one or more processors to change the character associated with the first key from the first character to the second character such that selection of the first key causes the second character to be input to the computing device; and
instructions that cause at least one processor from the one or more processors to cause the second character to be displayed on the first key.

12. A system comprising:
a memory configured to store reference information for a language; and
one or more processors coupled to the memory, the one or more processors configured to:
cause a software keyboard comprising a plurality of keys to be displayed, the plurality of keys including a first key;
determine a text portion to be used for selecting a character from a plurality of characters to be associated with the first key;
determine, based upon the text portion and the reference information, a first character, from the plurality of characters, to be associated with the first key;
cause the first character to be associated with the first key such that selection of the first key causes the first character to be input to the computing device; and
cause the first character to be displayed on the first key of the software keyboard.

13. The system of claim 12 wherein the first character is a diacritical mark or a punctuation mark.

14. The system of claim 12 wherein the one or more processors are configured to:
determine a second character from the plurality of characters to be associated with the first key instead of the first character, the second character being different from the first character;
cause the character associated with the first key to be changed from the first character to the second character such that selection of the first key causes the second character to be input to the computing device; and
cause the second character instead of the first character to be displayed on the first key.

15. The system of claim 12 wherein:
the reference information is a set of rules for the language; and
the one or more processors are configured to:
determine the text portion based upon a cursor position; and
determine the first character by applying one or more rules from the set of rules to the text portion.

16. The system of claim 12 wherein:
the reference information is a dictionary of words for the language; and
the one or more processors are configured to:
determine the text portion based upon a cursor position;
identify a set of one or more words from the list of words based upon the text portion; and
determine the first character based upon the set of one or more words.

17. The system of claim 12, wherein the one or more processors are configured to determine the text portion based upon a cursor position.

18. The system of claim 12, wherein the one or more processors are configured to:
receive, after the first character is associated with the first key, a signal indicating selection of the first key; and
responsive to receiving the signal:
identify a character immediately preceding a cursor; and
modify the character using the first character.

19. A system comprising:
a memory configured to store reference information for a language; and
one or more processors coupled to the memory, the one or more processors configured to:
cause a software keyboard comprising a plurality of keys to be displayed by a computing device, the plurality of keys comprising a first key associated with a first character from a plurality of characters;
determine a second character from the plurality of characters to be associated with the first key instead of the first character, the second character being different from the first character;
cause the character associated with the first key to be changed from the first character to the second character such that selection of the first key causes the second character to be input to the computing device; and
cause the second character to be displayed on the first key.

20. A method comprising:
displaying, by a computing device, a software keyboard comprising a plurality of keys, the plurality of keys including a first key;
determining, by the computing device, a text portion to be used for selecting a character, from a plurality of characters, to be associated with the first key;
determining, by the computing device, based upon the text portion and reference information for a language, a first character to be associated with the first key from the plurality of characters;
associating, by the computing device, the first character with the first key such that selection of the first key causes the first character to be input to the computing device; and
displaying, by the computing device, the first character on the first key of the software keyboard.

21. The method of claim 20 further comprising:
determining, by the computing device, a second character from the plurality of characters to be associated with the first key instead of the first character, the second characters being different from the first character;
changing, by the computing device, the character associated with the first key from the first character to the second character such that selection of the first key causes the second character to be input to the computing device; and
displaying, by the computing device, the second character on the first key instead of the first character.

22. The method of claim 20 wherein:
the reference information is a set of rules for the language, a list of words for the language, or a lookup table; and
determining the text portion comprises determining the text portion based upon a position of a cursor.

23. The method of claim 20 further comprising:
receiving, after the associating, a signal indicating selection of the first key; and
responsive to receiving the signal:
identifying a character immediately preceding a cursor; and
modifying the character using the first character.
